(19) United States
(12) Patent Application Publication
(10) Pub. No.: US 2003/0067961 A1
(43) Pub. Date: Apr. 10, 2003

(54) Wireless spread spectrum communications system, communications apparatus and method therefor

(76) Inventors: John E. Hudson, Essex (GB); David G. Steer, Nepean (CA); Roshdy H. M. Hafez, Nepean (CA)

Correspondence Address: William M. Lee, Jr., Lee, Mann, Smith, McWilliams, Sweeney & Ohlson, Suite 410, 209 South LaSalle Street, Chicago, IL, 60604-1202, US

(21) Appl. No.: 09/970,627

(22) Filed: Oct. 4, 2001

(51) Int. Cl. H04K 1/00

(52) U.S. Cl. 375/130

(57) ABSTRACT

Wireless communications systems exist, such as 3G systems, in which voice services as well as internet access is provided to mobile terminals. In such systems the number of terminals that can be supported per basestation is limited and it is not possible to provide fast or substantially “instant” uplink access to all those supported terminals. It is desired to increase the number of terminals that can be supported by a single basestation whilst allowing each of these terminals to have fast substantially “instant” uplink access, for example, for internet access. To address this, substantially continuous pilot signals are provided from all user terminals supported by a basestation, to that basestation. The continuous signals comprise repeated spreading code words with a high spreading factor such that the background noise level is not increased to unworkable levels. The continuous signals are used to alert the basestation of requests to send uplink data as well as to actually send uplink data.

### FIELD OF THE INVENTION

The present invention relates generally to a wireless spread spectrum communications system. The present invention also relates to a terminal and a basestation for use in the above spread spectrum communications system. The present invention is applicable to wireless access uplink communications between a fixed or mobile user terminal and a basestation, for example for internet access, and for mobile terminals which are hand-held or portable.

### BACKGROUND OF THE INVENTION

Wireless communications systems exist, such as 3G systems, in which voice services as well as internet access is provided to mobile terminals. The term “3G Systems” refers to third generation wireless communications systems such as the Universal Mobile Telecommunication System (UMTS) and General Packet Radio Service (GPRS). In such systems the number of terminals that can be simultaneously connected to a basestation is limited as it is not possible to provide a continuous uplink access to all those supported terminals. It is desired to modify this situation: to increase the number of terminals that can have fast substantially “instant” uplink access of limited bit rate, for example, for control of internet access.

FIGS. 1b and 1c are schematic diagrams of a prior art method of uplink access between a wireless terminal and a basestation. These demonstrate why such prior art methods do not provide “instant” uplink access for all users supported by a basestation. In such prior art methods, power ramping and base acknowledgement can take up to 80 milliseconds. FIG. 1b is a schematic diagram of a prior art method by which a mobile terminal can access a basestation in a 3G wireless communications network.

The upper line 101 in FIG. 1b represents actions of the terminal whilst the lower line 102 in FIG. 1b represents actions of the basestation. Time is represented from left to right across the page. First the terminal sends random access channel (RACH) bursts 100 with increasing power until the bursts are received 103 by the basestation.

Because the RACH bursts are sent from the terminals when they need to request service, there is a possibility that more than one terminal will burst at the same (or overlapping times) and there will be a collision. This typically results in one (or both) of the requests becoming lost and there is a delay before the request can be repeated when the RACH is again clear for use. This possibility of collision becomes more likely if there are a very large number of user terminals under control of the basestation. In these cases the delay in processing access requests can rapidly become very long as each collision requires additional attempts to become successful and this rapidly multiplies the request traffic. Systems using the RACH technique for signalling access requests thus are only suitable for small numbers of user terminals. It is an objective of this invention to provide a signalling request method that is both suitable for a large number of users and has very low delay. Such a method may be referred to as “contentionless”.

Once the basestation is aware of the terminal's request for a connection (which takes place via a dedicated random access channel [RACH] in 3G terminology) it allocates radio resources and signal processing capacity to that terminal. Once acknowledged by the base station, the terminal typically sends a continuous pilot signal to the basestation 104. A plurality of other terminals are also able to do this at the same time. However, not all terminals that are within range of the basestation are allowed to radiate a continuous pilot signal to the basestation because of mutual interference; only a subset of the supported terminals within range can do so.

When a user of the terminal sends an uplink signal, for example, by clicking on a web page “hot link” the terminal incorporates an uplink packet 105 in the continuous pilot signal which contains, amongst other things, the URL (universal resource locator) associated with the hot link. The basestation receives the uplink packet containing the URL and sends the internet address of the terminal to the web server specified by the URL. The requested web page is then sent back to the terminal from the web server in a packet stream 106.

It is often the case that uplink requests from the terminal to the basestation are relatively infrequent and sending the continuous pilot signal is a waste of resources. The 3G standards get round this by two modes of operation. Short uplink packets can be sent as an attachment to the RACH burst while for longer uplink messages the terminal requests a dedicated packet channel for a finite time. Within the time that the uplink channel is activated the terminal sends a continuous pilot signal, though the data packets may be infrequent. In the first method the base has no memory of the terminal and further data packets need further RACH bursts. However the process involving the RACH bursts is time consuming since the terminal uses a power ramping method to find a suitable carrier operating level every time. This is illustrated in FIG. 1c which shows a terminal sending uplink requests spaced apart in time by about 1 to 5 seconds. For example, this might occur when a user operates wireless internet applications. The terminal sends short bursts 105 on the uplink, arising from mouse clicks or games joystick movements, while the base responds with much longer data flows 106 from web pages or applications. In the second method, if the uplink packets are infrequent (e.g. more than 1 to 5 seconds apart) the terminal will turn the continuous pilot signal 104 off and become “cold”. For subsequent uplink packets, the terminal must then use the time consuming RACH burst procedure of FIG. 1b.

FIGS. 1b and 1c illustrate how, in a packet data cellular communications system, most terminals (typically using the Internet) are quiescent for long periods of time. However, when the terminals try to communicate with a basestation, for example in response to a mouse click or key press, a complex channel acquisition procedure has to be completed which can take a relatively large fraction of a second or could fail altogether if the communications system is congested.

The mouse click and the key press are examples of a need to communicate relatively low amounts of data from a terminal to a basestation. For example about 28 bytes for a minimum uplink packet containing just a URL as compared with about 30 Kbytes for a web page download. Other examples of uplink messages with relatively small size include: access requests, acknowledgements, negative acknowledgements, and data generated by other input devices.

The Third Generation Partnership Project (3GPP) specification for a third generation cellular telecommunications system, the Universal Mobile Telecommunications System (UMTS), defines a Random Access CHannel (RACH) and a Dedicated Physical Control CHannel (DPCCH) for uplink communications from a terminal to a basestation. In the 3GPP system, the basestation is also referred to as “Node-B”. The RACH is essentially a circuit oriented technique for granting access to a basestation for a relatively lengthy period of a telephone call. The RACH takes some 100 ms to function. In the example of the telephone call, the set up time does not represent a significant proportion of the call duration. In contrast, for the transmission of the data messages of relatively small size such as an uplink packet, the set up time associated with the RACH represents a significant proportion of the uplink message duration. Furthermore, as downlink wireless bit rates increase through advancing technology, a corresponding need for increased rapid uplink signalling of acknowledgements and access requests will grow, otherwise average downlink user bit rates and latency will be limited by uplink rather than downlink inefficiencies. Thus, the RACH is not a sufficient mechanism for communicating brief messages for a large number of users.

In order to overcome the drawback of the RACH process, a number of contentionless access channels comprising pseudo-noise (PN) sequences have been proposed as alternatives to the 3G-style RACH. The contentionless access channels are deterministic in nature and independent of scheduled data and control traffic flows. The access channels are supported by direct spreading sequence signals for carrying the low bit rate data messages, thereby avoiding collision problems of conventional slotted ALOHA access (as used in Ethernet), and providing faster access than the RACH.

One contentionless access channel is an initial access channel proposed by S. Songson, A. Krzymien and B. Darian in “A new efficient contentionless access protocol for packet data transmission in CDMA systems” (Vehicular Technology Conference Proceedings, 2000. VTC 2000—Spring, Tokyo. 2000 IEEE 51^{st}, Volume: 1, pages 36-40). In this document, the access channel is based on a hybrid spread spectrum/time division multiple access (TDMA) contentionless rapid access protocol. Access probes are offset from one another in time and each terminal within a cell uses an identical, cell-specific PN sequence. The offset in time between terminals is greater than a round-trip time of an uplink burst plus delays attributable to multipath dispersion effects. The offset in time between the access probes avoids collisions between the access probes from the different terminals. Typically, a given terminal is quiescent, only transmitting the spreading codes on the uplink when access is required by the given terminal. The basestation broadcasts a list of unused access channels (i.e. code word time offsets or slots) and a terminal wishing to access the basestation transmits a spreading code in the one of the unused access channels (slots). At the basestation, the spreading code word is received and demodulated. In this initial access technique, a power ramping stage is carried out by the given terminal. Thus this method suffers from the drawback that a time consuming power ramping phase is necessary for initial uplink access.

In: “A comparison of uplink channel estimation techniques for MC/JD-CDMA transmission systems” by B. Steiner and R. Valentin (Proceedings IEEE 5^{th} International Symposium on Spread Spectrum Techniques and Applications, 1998, Volume: 2, pages 640-646) a method for uplink channel estimation promoted by the 3GPP standards body is described. This technique is described in the form of a channel estimation procedure but uses the same method of shifted code words to separate different users as in the Songson method above and includes an efficient Fast Fourier Transform method for correlating the differently offset code words at the receiver. This FFT algorithm can be used advantageously as a component part of the receiver signal processing for the proposed fast access applications technique proposed herein.

Another contentionless access channel is disclosed and discussed in “The FAUSCH Concept” (R1—(99)042, Philips, 3GPP meeting #2, WG1, February 1999), “Comments and Questions on FAUSCH from ARIB members” (R1—(99)093, Fujitsu, LSI Logic, Panasonic, NEC, Nokia Mobile Communications, NTT DoCoMo, Texas Instruments),; “Initial Response to Comments and Questions on FAUSCH from ARIB members”, (R1—(99)094, Philips) both from Meeting #2 22-25th, Feb., 1999 and “Update of FAUSCH scheme and text proposal” (R1—(99)823, Philips, 3GPP meeting#6, WG1, July 1999). These documents discuss the concept of a Fast Uplink Signalling Channel (FAUSCH). Phillips considered the scenario of on-line game playing where uplink internet protocol packets originating from a computer games joystick could have a frequency of 10 per second. This together with the recognition that when only a small message is to be conveyed, the overhead associated with the use of the RACH is significant, led them to develop FAUSCH.

The FAUSCH method involves requesting a dedicated channel in the uplink direction for access signalling by a limited number of users rather than using continuous uplink channels for all users. This means that there is necessarily some delay when it is required to make an uplink request from a terminal which has no current uplink channel. A cell specific code sequence is transmitted in a dedicated access slot in order to request a dedicated channel in the up-link direction. FAUSCH is beneficial for uplink packet transmission in those cases where a continuous dedicated uplink channel for all users is not appropriate.

In the context of wireless communications, the present invention seeks to support unscheduled uplink packets arising from pointing devices, PC mice and similar peripherals without going through the complex mechanism of sending a RACH data burst. Such RACH data bursts have a significant latency, especially if the channel is fading and the power control is unreliable. It is desired to support such unscheduled uplink packets from all user terminals that are serviced by a particular basestation.

Further benefits and advantages of the invention will become apparent from a consideration of the following detailed description given with reference to the accompanying drawings, which specify and show preferred embodiments of the invention.

### SUMMARY OF THE INVENTION

According to an aspect of the present invention there is provided a method of achieving uplink communication from a user terminal to a basestation in a wireless communications system said basestation supporting a plurality of such user terminals; said method comprising the steps of:

For each of a plurality of the user terminals supported by the basestation, transmitting a substantially continuous signal simultaneously from that user terminal to the basestation, said signal comprising a repeated spreading code word with a spreading factor and power level arranged such that the signal does not cause significant interference at the basestation in use even when more than 250 user terminals simultaneously transmit such continuous signals to the basestation; and

when a particular user terminal requires to send uplink information to the basestation, indicating this to the basestation by modulation of the substantially continuous signal from that user terminal to the basestation.

This provides the advantage that because a continuous signal is present between each terminal and the basestation, it is not necessary to carry out a complex, time consuming, channel acquisition procedure each time uplink information needs to be sent. Also this is possible for more than 250 user terminals unlike in the known 3G systems which use RACH methods. Preferably, said indication is made by any or all of:

inverting the phase of the spreading code word;

applying a cyclic shift to the spreading code word;

applying high order quadrature amplitude modulation (QAM) to the spreading code word;

sending additional spreading code words in parallel with the spreading code word of the substantially continuous signal.

Each of these methods provides a simple, fast and effective way in which the continuous signal can be used to inform the basestation of an uplink request.

Advantageously said step of indicating to the basestation by modulation further comprises sending uplink information from the particular user terminal to the basestation using the substantially continuous signal from that user terminal to the basestation and by increasing the information rate of that substantially continuous signal whilst the uplink information is sent. The information rate of the continuous signals is very low and this provides a way in which that rate can be increased to send uplink information This can be achieved by any or all of:

using a temporarily reduced spreading factor

sending additional spreading code words in parallel with the spreading code word of the substantially continuous signal.

These are all simple and effective ways in which the information rate of the continuous signal can be increased.

Preferably during said step of transmitting a substantially continuous signal, the spreading factor is about 4096 or higher. For example, spreading factors in the range 4096 to 65536 are appropriate for word durations of about 1.06-17 ms as described below.

According to another aspect of the present invention there is provided a method of operating a basestation in a wireless communications system, said basestation supporting a plurality of user terminals, said method comprising:

receiving a substantially continuous signal simultaneously from each of a plurality of the user terminals supported by the basestation, said signals comprising a repeated spreading code word with a spreading factor and power level arranged such that the resulting background noise level is prevented from causing significant interference at the basestation in use even when more than 250 user terminals simultaneously transmitting such continuous signals to the basestation; and

receiving an indication from one of the user terminals which requires to send uplink information to the basestation, said indication being provided by a modulation of the substantially continuous signal from that user terminal to the basestation.

According to another aspect of the present invention there is provided a basestation for use in a wireless communications system and arranged to support a plurality of user terminals, said basestation comprising:

an input arranged to receive, at the same time, a substantially continuous signal from each of a plurality of the user terminals supported by the basestation, said signal comprising a repeated spreading code word with a spreading factor and power level arranged such that the resulting background noise is prevented from causing significant interference at the basestation even when more than 250 user terminals simultaneously transmit such continuous signals to the basestation; and

wherein said input is further arranged to receive an indication from one of the user terminals which requires to send uplink information to the basestation, said indication being provided by a modulation of the substantially continuous signal from that user terminal to the basestation.

According to another aspect of the present invention there is provided a user terminal for use in a wireless communications system said user terminal being one of a plurality of terminals supported by a basestation in the wireless communications network; said user terminal comprising:

a transmitter arranged to transmit a substantially continuous signal to the basestation, said signal comprising a repeated spreading code word with a spreading factor and power level arranged such that in use the resulting background noise level is prevented from causing significant interference at the basestation even when more than 250 user terminals simultaneously transmit such continuous signals to the basestation; and

a processor arranged to modulate the substantially continuous signal in order to indicate to the basestation that it is required to send uplink information.

It is thus possible to provide an access channel or a dedicated low bit rate channel that enables a basestation to track fading of a user terminal, thereby permitting continuous power control even when the user terminal is not transmitting useful data and eliminating the usual power ramping when the user terminal begins to transmit data on the uplink in a conventional RACH arrangement. Additionally, the basestation is able to track changes in uplink channel impulse responses, thereby permitting the channel to be used in a coherent demodulation mode from the onset of a new data flow. The basestation is also able to keep the user terminal in a time-synchronised state. It is thus possible to provide a one-bit signalling channel for indicating a status change in the user terminal, for example a request for an uplink data channel. It is also thus possible to facilitate the ability to near-instantly transmit multiple bits of signalling data on the uplink.

### BRIEF DESCRIPTION OF THE DRAWINGS

At least one embodiment of the invention will now be described, by way of example only, with reference to the accompanying drawings, in which:

FIG. 1 is a schematic diagram of a cellular communications cell comprising a basestation and a terminal arranged to carry out the present invention;

FIG. 1b is a schematic diagram of a prior art RACH process;

FIG. 1c is a schematic diagram of prior art operation of a terminal with infrequent access;

FIG. 2 is a schematic diagram of the basestation of FIG. 1;

FIG. 3 is a schematic diagram of the user terminal of FIG. 1;

FIG. 4 is a schematic diagram of signal transmissions between the basestation and the terminal of FIG. 1 constituting an embodiment of the invention;

FIG. 5 is a flow diagram of a method of communication between the basestation and the terminal of FIG. 1 constituting an embodiment of the invention using phase reversal of a code word;

FIG. 6 is a schematic diagram of data transmission using QPSK modulation;

FIG. 7 is a schematic diagram of data transmission using extra uncorrelated code words;

FIG. 8 is a schematic diagram of data transmission using shifted versions of one code word;

FIG. 9 is a flow diagram of data transmission using shifted versions of one code word.

### DETAILED DESCRIPTION OF INVENTION

Embodiments of the present invention are described below by way of example only. These examples represent the best ways of putting the invention into practice that are currently known to the Applicant although they are not the only ways in which this could be achieved.

As mentioned above it is desired to create a system in which user terminals such as PCs or laptops, and mobile or portable communications terminals can be provided with high bandwidth communications in a cost effective manner and in which uplink access is substantially instant for all terminals supported by a basestation.

Consider a situation in which a user has a personal computer (PC), laptop, or other terminal and wishes to have high bandwidth communications, for example, for internet access. One option is to provide the user with a wireless modem and an antenna for connection to his or her terminal, such as is presently available in the form of a PCMCIA card for WLAN applications, and software for controlling the modem and antenna in order to enable high bandwidth communications with a basestation. The antenna may be external to the user terminal, connected by a flexible cable, or may be internally mounted. In this way a relatively low cost communications system is provided since once a communications provider has installed basestations, the costs of the user terminals is low and they do not need expert installation.

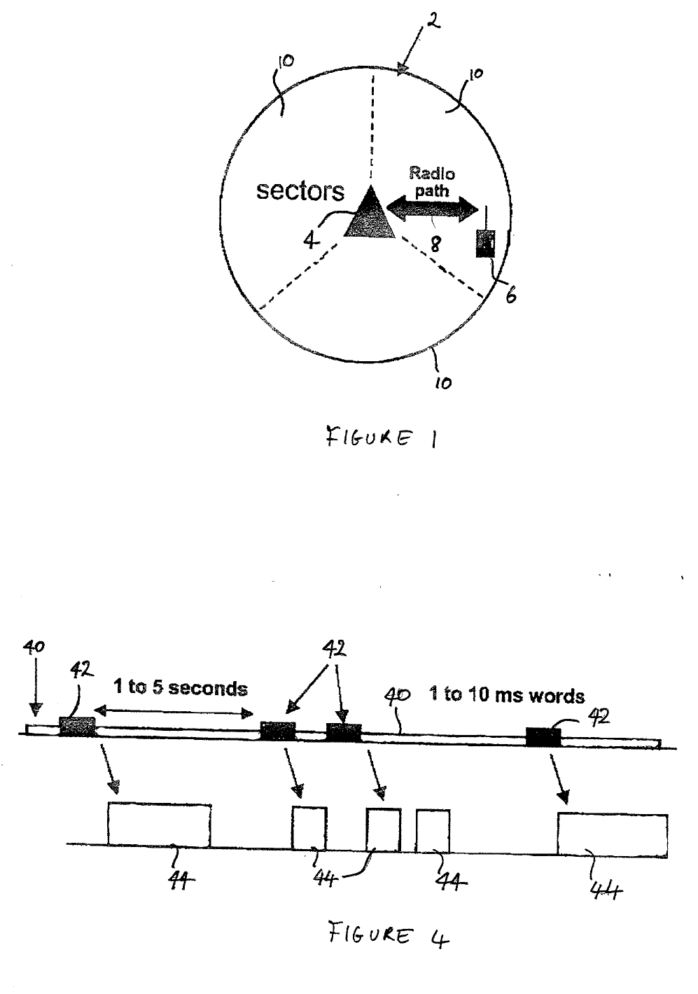

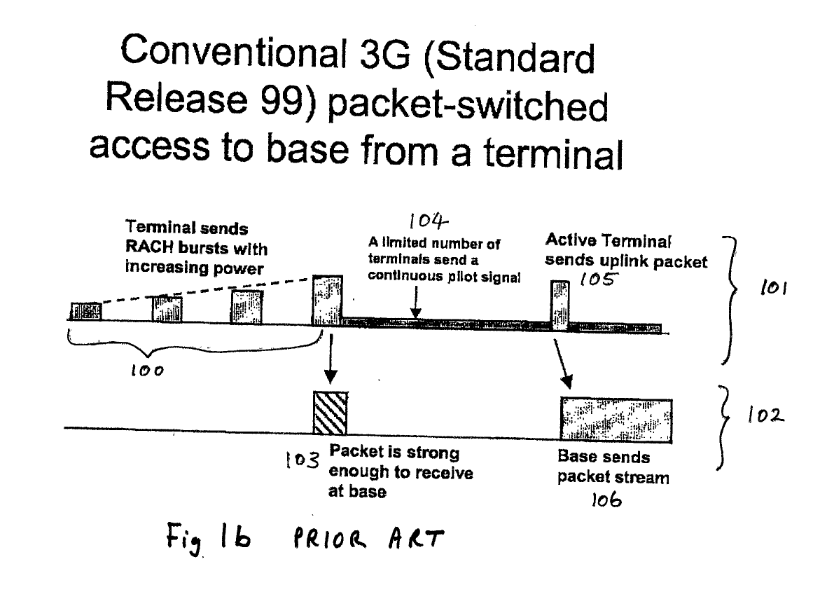

The present invention enables substantially instant uplink access to be provided to each user terminal supported by a basestation by arranging each user terminal to send a continuous signal to the basestation. For example, FIG. 1 shows a basestation 4 which supports a plurality of user terminals which are located within an area around the basestation referred to as a cell 2. Three sectors 10 are provided in the cell as is known in the art although this is not essential for the present invention. One user terminal 6 is illustrated, for example, a PC with an antenna. It communicates with the basestation via a radio frequency medium 8 as is known in the art.

By sending continuous signals from each terminal in the cell 2 to the basestation 4 the danger is that the background noise level increases significantly when there are many simultaneous users. (When we say “many” here we mean more users than can currently be supported using known 3G systems. For example, current 3G systems support about 250 users whereas the present invention enables up to 1000 or more users to be supported.) In order to avoid this, large spreading factors, low bit rates, and low carrier powers are used. Spreading code words of a relatively high spreading factor are transmitted as the continuous signals. The spreading factor is the ratio of the number of chips per spreading word to a user bit. For example, the present invention uses spreading factors in the order of 4096 and above whereas standard 3G data systems typically use spreading factors of between 4 and 512. Thus in the present invention terminals are able to send a continuous access signals of extremely low power which, to compensate, have a high correlation gain at the receiver. For a 3.84 MHz chipping rate, spreading factors in the range 4096-65536 are appropriate with word durations of about 1.06-17 ms. Because of the large spreading factor the access signal will operate some 27 dB below a typical data signal and have an EIRP (effective isotropic radiated power) in the microwatt region so battery consumption in a portable terminal is not an issue. For example, if the data signal is at 10 mW (10 dBm) then the access signal radiated power is 20 microwatts. This is an example of a “low” carrier power as referred to above. The continuous spread spectrum signal is also referred to as a deterministic access channel and may for example be a code division multiple access (CDMA) channel.

By using continuous signals from all of the terminals in the cell in this way, those signals are always available to request uplink access. In addition, the continuous signals enable the base station to track the channel characteristics and fading user power at all times. However, because high spreading factors are required for the low power continuous signals, the resulting information rate is low; 940 bps and 58 bps for spreading factors of 4096 and 65536 respectively. For example a minimum length uplink packet of about 28 Bytes in size would take approximately ¼ second to send using a continuous low power signal with a spreading factor of 4096. The present invention addresses this low data rate problem in several alternative ways, many of which can be combined, as described below.

As mentioned above several different methods can be used to increase the information rate.

The different methods used to increase the information rate comprise:

using shorter spreading code words that are phase modulated, or modulated with a high order QAM (quadrature amplitude modulation). A high order QAM is generally understood to be higher than about 4 QAM (QPSK).

sending multiple spreading code words in parallel.

using cyclic pulse position modulation of the spreading code words.

using a higher order modulation such as QPSK or 16-QAM.

a combination of any of the above.

These higher bit rate methods all demand increased carrier power (an inevitable consequence of Shannon's channel capacity theorems) and can be thought of as sending the faster uplink data in a “power bulge profile”. During such a “power bulge” interference to other users is increased but difficulties do not arise at the basestation because the number of user terminals making “power bulges” at the same time is relatively low and the interference does not preclude the signals being properly decoded at the basestation.

The continuous spread spectrum signal used in the present invention serves several important functions in addition to keeping the uplink channel alive, and these comprise:

the base can track changes in the terminals' fading so that terminal power control is continuous even when the terminal is not sending data.

the base can also track changes in the channel impulse response.

It acts as one-bit signalling channel to indicate a status change in the terminal, typically a demand for an uplink data channel.

Multiple bits of signalling data can be uplinked instantly when necessary by augmenting the code word with extra words bearing information.

Terminals are kept synchronised even when mobile

It allows quiescent terminals to perform a hand off between sectors or bases without actively sending of data on the uplink.

Spreading Code Words

In order that the basestation is able to identify the continuous signal of a particular terminal various different methods can be used. For example, each terminal in the cell can be allocated a unique spreading code word. Alternatively, all terminals in the cell use the same spreading code word but these are differentiated by a cyclic shift of the word. This method is preferred for reasons of simplicity in demodulation of the continuous signals received at the basestation. The cyclic offset is arranged to indicate a terminal's identity and is also arranged to be greater than the channel dispersion plus radio travel time. To avoid confusion of transmission delay with terminal time offsets the cyclic offsets must be sufficiently large. For example, consider a case where the unknown travel time can be as great as 10 μs and the code word duration is 4.26 ms. In this case the cyclic offset could be set to 15 μs, and the maximum number of users is 4260/15˜284. It is also possible for the base to estimate the minimum round trip corresponding to the first propagation arrival at the terminal and arrange for it to compensate the delay time by transmitting its code words early. This increases the system capacity. If the capacity provided by one code is insufficient, that is all the delay allocations are used up, then additional code words can be brought into use. The length of the code word can also be increased to allow greater capacity though at the cost of increased latency. It is also possible to have a mix of users with different code word lengths so long as fundamental near-orthogonality properties are met.

The channel used by the continuous pilot signal is hereinafter referred to as the Deterministic Access Channel or DACH.

Resolving Composite Data at the Basestation

The composite data from all the continuous signals received at the basestation is resolved in the time domain using a single application of a Digital Fourier Transform (DFT) deconvolution as is known in the art. This is very digital signal processing (DSP) or load efficient. Preferably a Weiner MMSE (minimum mean square error) technique is used in this deconvolution to avoid error build up, although this is not essential. This is one example of how the composite data is resolved at the basestation. Any other suitable method can be used as is known in the art.

The above processing is expressed mathematically as follows:

yₖ=cₖ\mathring{x}hₖ

Hence

Yₖ=Cₖ·Hₖ, k=o . . . N−1

Where:

hₖ is the impulse response of the DACH,

cₖ is the spreading code word,

yₖ is a received data block from the user terminal 6, and

Hₖ, Cₖ and Yₖ are the discrete spectra of hₖ, cₖ and yₖ respectively

X·Y means a point by point product

x\mathring{x}y means a circular (wrap-round) convolution;

The conventional linear correlation to obtain the channel estimate gₖ of the DACH is:

gₖ=c*₋ₖ\mathring{x}yₖ(convolution)

In the frequency domain, this becomes:

Gₖ=Cₖ*·Yₖ k=0 . . . N−1

Where Gₖ is the discrete N-point FFT spectrum of the channel estimate gₖ of the DACH.

Straightforward linear correlation of the users' code words with a reference is only successful for small numbers of users. With large numbers there is a build up of mutual interference and the Signal to Noise Ratio (SNR) of the channel estimate falls. This is largely avoided by using a Weiner estimate of the channel impulse response:

$${\hat{G}}_{k} = \frac{{C}_{k} \cdot {Y}_{k}}{{σ}^{2} + \vert {C}_{k} {\vert}^{2}} k = 0 … N - 1$$

Where Ĝₖ is the Wiener MMSE (minimum mean square error) estimate of Gₖ and τ² is the variance of the thermal noise in the FFT bins. The MMSE method also compensates for the possibility of a non-uniform Fourier spectrum of the pseudo-random sequence C.

Basestation and User Terminal Structure

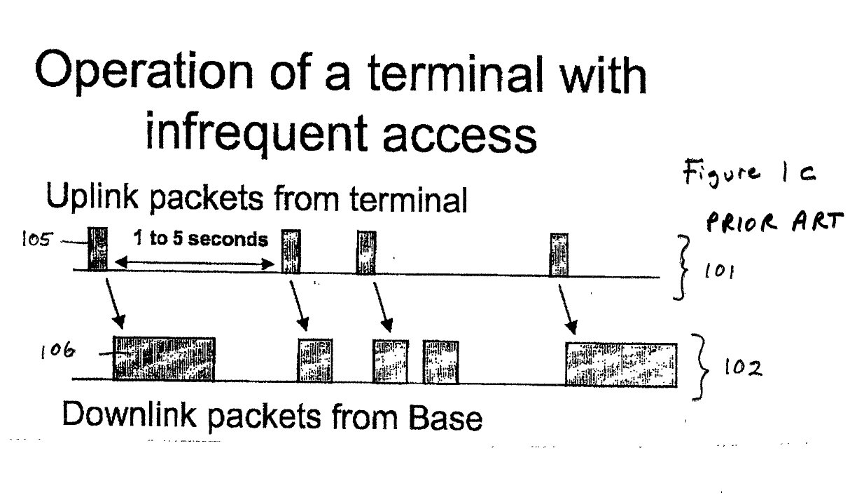

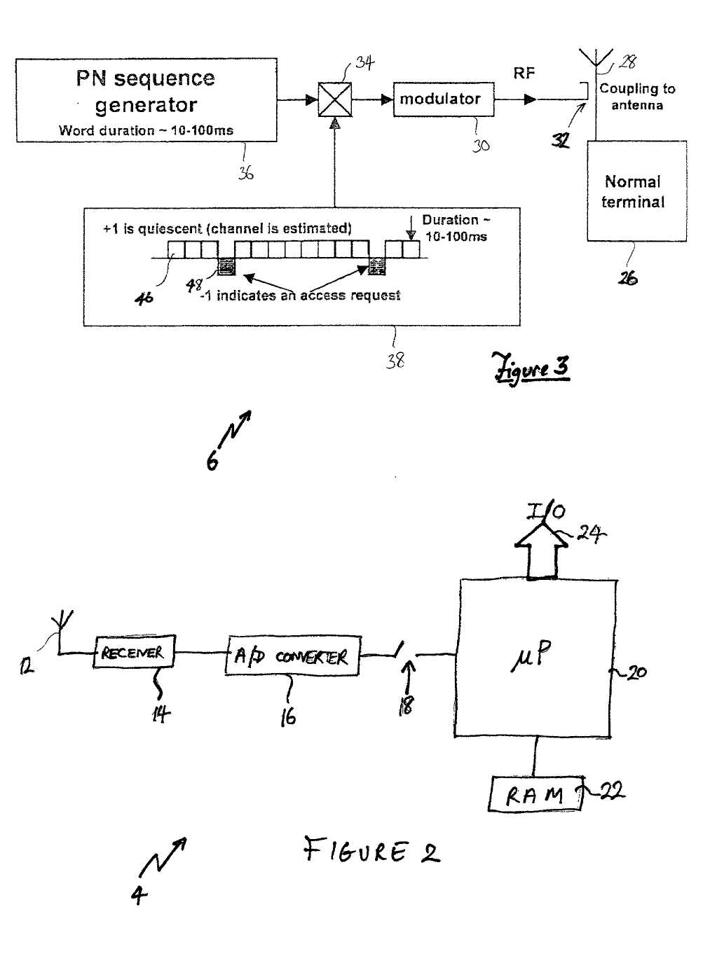

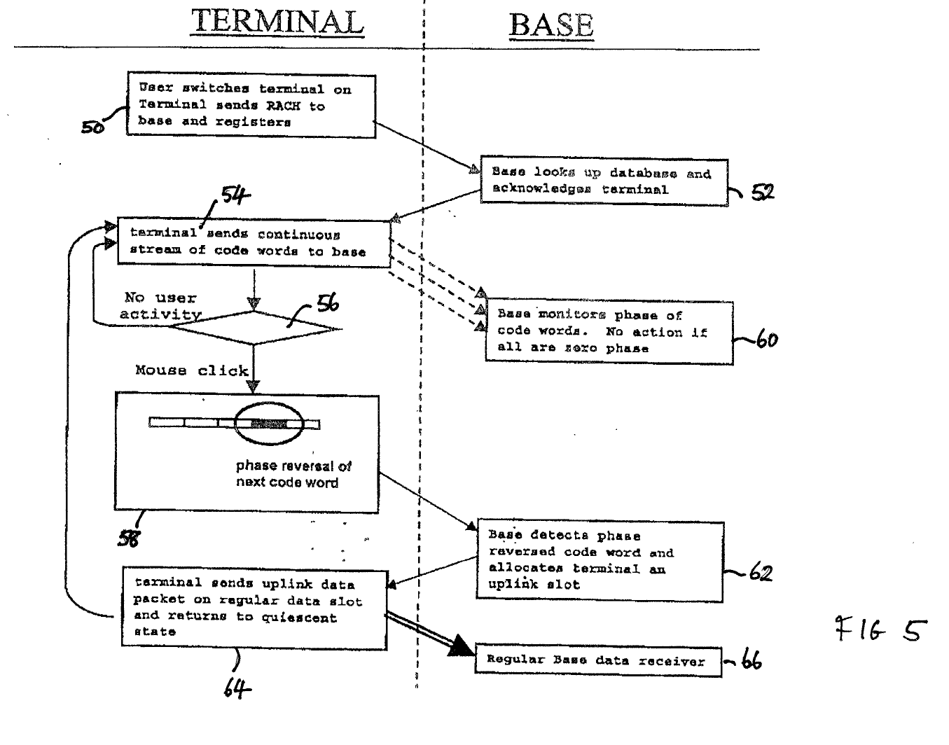

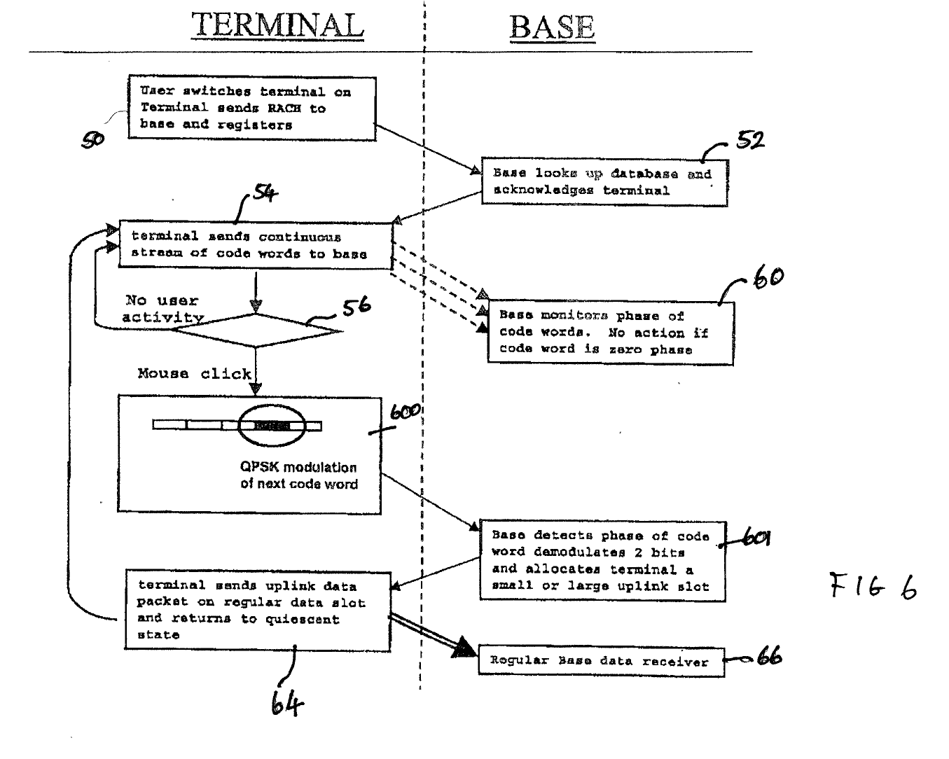

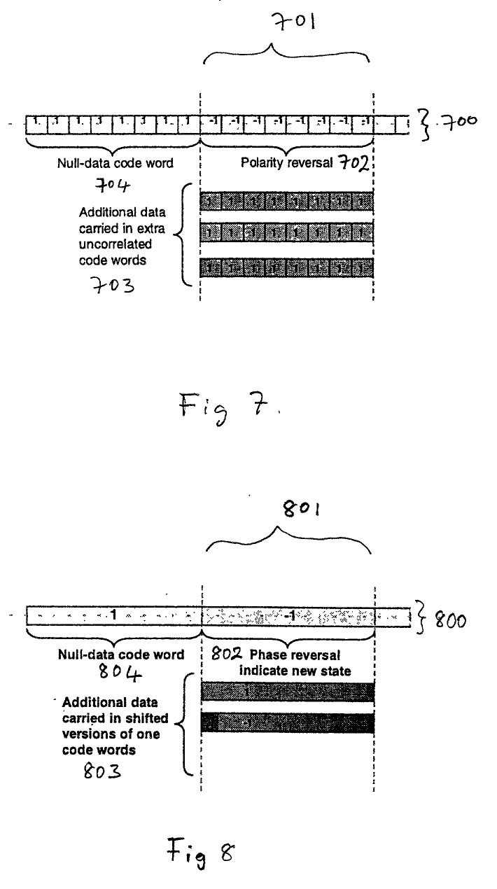

The basestation and user terminals themselves may have any suitable structure as is known in the art. For example, the basestation receiver may be formed as illustrated schematically in FIG. 2, and the user terminal transmitter may be a standard UMTS terminal as shown in FIG. 3, with an RF coupling of the DACH signals into the antenna, or any other suitable type of user terminal.

Referring to FIG. 2, the basestation 4 comprises an antenna 12 coupled to a receiver chain 14, the receiver chain 14 being coupled to an analogue-to-digital (ND) converter 16. The A/D converter 16 is coupled to a first microprocessor 20 via a sampler 18 which may operate at the chip rate or a multiple thereof. A memory, for example a Random Access Memory 22, is coupled to the first microprocessor 20, the first microprocessor 20 also being coupled to an input/output (110) port 24.

Turning to the user terminal 6 (FIG. 3), this comprises an antenna 28 which communicates with basestation 4. The DACH signals may be added by coupling a signal from modulator 30 into the antenna using an RF directional coupler 32 or they may also be injected as a low level digital signal into the existing digital modulator of the terminal. The modulator 30 is coupled to a signal mixer 34, the signal mixer 34 being coupled to a pseudo-noise (PN) sequence generator 36 and a second microprocessor 38. Alternatively, instead of adapting the known UMTS user terminal 26, the user terminal 26 can be custom built to have the above described structure and hence communicate with the basestation 4 such that a practical implementation of the DACH method would simply use existing signal processing capability within the terminal.

During operation of the user terminal and basestation, (FIG. 3), the second microprocessor 38 generates information that multiplies the spreading code word generated by the PN sequence generator 36 in the signal mixer 34 to yield a continuous pilot signal 40 (FIG. 4) that modulates a carrier in modulator 30 and is transmitted to the basestation 4 via the antenna 28. The modulator 30 derives its carrier signal from a reference point in the terminal 26. When it is necessary to communicate information to basestation 4, the pilot signal 40 is modulated with information 42, and where necessary, the basestation 4 responds with downlink packets 44.

The information can be one or more data bit for conveying content, or signalling information, for example, a request for an uplink data channel.

It will be understood that a new terminal appearing in a cell will be admitted to a network or not according to a standard registration process as occurs in all cellular systems.

As described above, the pilot signal 40 is a continuous spread spectrum signal having a very large spreading factor. For example, for a chipping rate of 3.84 Hz, the spreading factor can be between about 4096 and 65536 with a word duration of between about 1.06 ms and 17 ms.

As mentioned above there are several different ways of increasing the information rate on the DACH to more than one bit. These extended bits can be used to indicate to the basestation to the fact that terminal has uplink information to send and also what parameters are to be used in the regular wideband data channel, such as bit rate, modulation method and so on. The DACH channel itself is only suitable to carry simple control signals which indicate to the base station what will be sent in the regular data channel.

Consider a first example of using shorter spreading code words that are phase modulated or modulated by a high order QAM. In a simple example of this, a positive binary signal 46 is continually repeated and mixed with a first spreading code word in FIG. 3 prior to transmission resulting in the pilot signal 40 (FIG. 4) comprising the first spreading code work repeating with no phase changes until it is necessary to send data to the node B 4. In this respect, the second microprocessor 38 of the user terminal 6 regularly monitors (step 56) for a need to transmit the low bit rate information. Upon detection of the need to transmit the low bit rate information, for example in response to an input device, such as a click of a mouse, the second microprocessor 38 generates a negative binary signal 48 that is mixed with the first spreading code word to invert the phase of a subsequent transmission of the first spreading code word (step 58) in the pilot signal to the node B, thereby conveying one bit of information.

Referring to FIG. 5, the node B 4 monitors (step 60) for the phase inversion of the first spreading code word 48 and then expects to receive a burst of data in a regular uplink data slot (not shown) associated with one of the regular wide band data channels. The user terminal (2)6 transmits (step 64) one or more packet of high bit rate data in an allocated uplink slot of the data channel to the node B 4, the node B 4 receiving (step 66) the one or more packet. The DACH channel meanwhile returns to a quiescent state with the pilot signal 40. Other means can be used in place of phase inversion to convey the request to send uplink information to the basestation.

Another example, in which shorter spreading code words are used to increase the number of bit sent on the uplink is now described. In addition to the long phase reversed code word a sequence of short code words is generated. These will typically be ½, ¼, ⅛, etc. the length of the original long code word. Each of those K segments is QAM (quadrature amplitude modulated) or phase modulated by a constellation with 2^{M} points in order to code M bits as is known in the art. The resulting segmented code word contains MK information bits. The first spreading code word is used as before to alert the base that the terminal has become active, the added short code words are demodulated by the base and their data content is used to set up the normal wide band receiver parameters or any other base station parameters. The extra shorter code words may be advantageously matched filtered with the channel impulse response which was previously estimated using the first long code word in order to improve signal to noise ratio.

Any other suitable type of modulation may be used on the long code words such as quadrature phase shift keying (QPSK) modulation as is known in the art. QPSK modulation is suitable for two-bit values such as an acknowledgement of a wideband downlink packet and the previously described “ready to send” message.

FIG. 6 is a flow diagram of this type of method where QPSK modulation of the second code word is used. This flow diagram is the same as that of FIG. 5 except that QPSK modulation (box 600) is used instead of phase reversal of the code word in order to send two bits to the basestation.

As mentioned above, another method of increasing the information rate of the continuous signal is by sending multiple long spreading code words in parallel. This is illustrated in FIG. 7.

It is also possible to use additional code words sent in parallel together with the QAM modulation discussed above. Consider K near-orthogonal code words that are sent in parallel, each modulated by a constellation coding M bits as is known in the art. The information content is then MK bits. The K code words can be formed by cyclic binary shifts of a single code word, they could also be Walsh codes or Gold codes as is commonly used in digital communications.

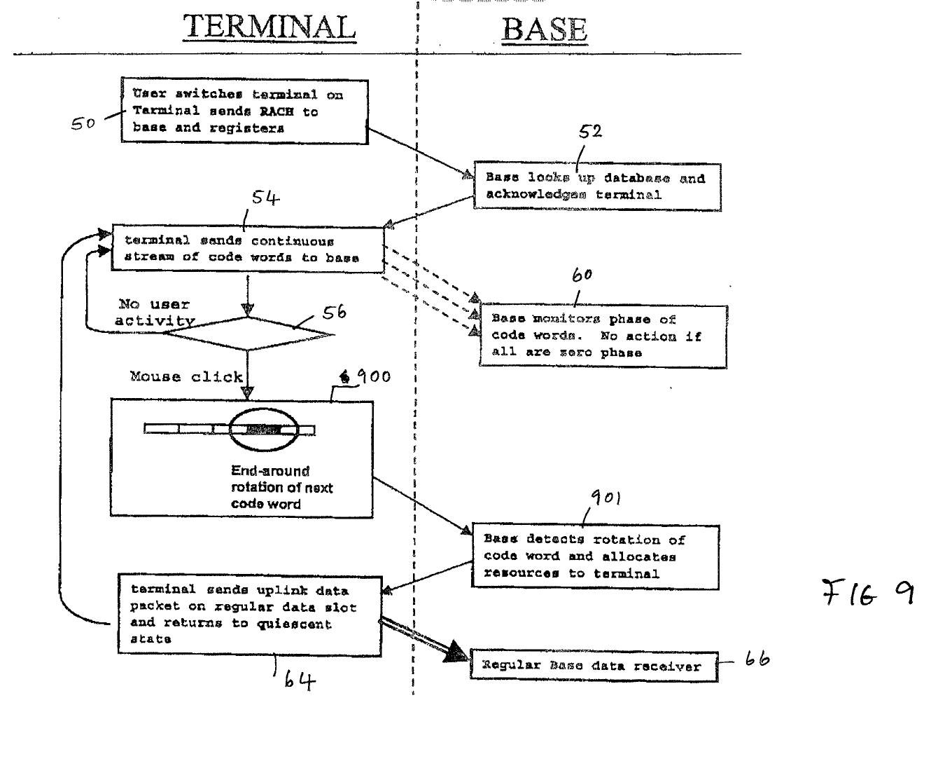

Another method of increasing the information rate of the continuous signal is by using cyclically shifted versions of the spreading code word to carry data. This is illustrated in FIGS. 8 and 9.

FIG. 8 shows a continuous signal 800. During transmission of uplink information (part 801) the polarity of the repeated spreading code word in the continuous signal is reversed 802. This indicates to the basestation that it should look for additional data carried in shifted versions 803 of the code word. After the uplink data is transmitted the continuous signal returns to normal 804 with a null-data code word.

FIG. 9 is the same as FIGS. 5 and 6 except that end-around rotation or cyclic shifting of code words is used to send the uplink data (see boxes 900 and 901).

In another embodiment, instead of allocating the second and third versions of the first spreading code word to the first user terminal 6 to increase the capacity of low bit rate data that can be transmitted to the basestation 4 by the first user terminal 6, the first version of the first spreading code word having the first offset in time is allocated to another user terminal. Similarly, the second version of the first spreading code word having the second offset in time is allocated to a third user terminal. The cyclic offsets of the first spreading code word are therefore used to provide multiple access.

Other ways of increasing the information rate of the continuous signal in order to transmit uplink information are possible including combinations of any of the methods described above.

Carrier to Noise Ratios

Determination of a suitable set of contentionless access carrier powers is a critical part of the system design. The overall power level must not be so high as to significantly impair the normal operation of the uplink data channels but not so low that uplink BER is significant. The ideal is to have all users having a code running at all times but this raises a latency problem is follows.

First of all we define the total power received from users' data signalling and thermal noise at the base station receiver as P_{U} and P_{TH} respectively. Because of the use of efficient turbo codes on the uplink it can be shown that P_{U} will be comparable to P_{TH} under normal system operating conditions. Assume that P_{U}=P_{TH} and define a total DACH power P_{D} at the base arising from all N terminals. The DACH codes are assumed to have the appearance of white noise to the data streams at the base. To avoid a significant increase in background noise we set P_{D}=(P_{TH}+P_{U})/4=P_{TH}/2 which corresponds to a 0.97 dB degradation. Next each terminal's DACH code, of power P_{D}/N, is demodulated with an SNR of at least 10 dB

$$γ = \frac{K {P}_{T H} / 2 N}{( {P}_{T H} + {P}_{T H} )} = \frac{K}{4 N} \geq 10$$

(Note that for simplicity, no efficient coding is used on the DACH transmissions). This equation implies that we must select a DACH spreading factor K such that K≧40N. If there are 1,000 terminals using DACH simultaneously then the spreading factor must exceed 40,000. At 3.84 MC/s for 3G UTRA this implies the duration of the code word is 10.4 ms and this is the minimum latency in the uplink signalling link. To bring this latency down to a quicker 2.5 ms with the use of shorter codes we can do various things:

(i) Only allocate 25% of the users an uplink signalling channel, 250 instead of 1,000.

(ii) Have the users operate in quiescent mode most of the time. That is, a carrier level of zero implies zero change in terminal status rather than the original zero phase change. However this method is equivalent to the Songson idea described earlier and it prevents continuous estimation of the uplink channel and terminal power control levels which is a major difficulty.

(iii) Use an adaptive allocation of spreading codes such that high downlink bit rate users have a short latency and higher power spreading codes while low data rate users have a large spreading factor and relatively small power. As an example we could allocate 100 users a (spreading factor) SF of 5100 and 900 users a SF of 46000 while holding the same noise increase.

(iv) Accept the greater increase of noise level which comes from using shorter codes. The only penalty in doing so is that the overall power levels of all terminals must be increased in their data mode to compensate for the extra noise. Thus if the noise increase were 3 dB then P_{D}=P_{TH}+P_{U} and we have K>10N. In this case we could allocate all 1,000 users a code word with SF=10,000 and the latency would be only 2.7 ms.

A combination of one or more of these options allows a useful compromise between increased terminal power and minimum latency.

The effect of the data signals on the signalling channels is significant. One rough approximation for traffic noise is to represent all uplink data traffic by a single user with a spreading factor of two and an Eb/No of 3 dB (turbo codes). This user will add to the thermal noise level by contributing a new noise with a power of 0 dB relative to thermal giving a resultant level of 3 dB. This means that signalling levels would have to increase by 3 dB. To address this, the data and signalling traffic can be orthogonalized. Orthogonalization can be done to a limited extent by building the signalling codes in segments using the orthogonal variable spreading factor (OVSF) tree. However if a MUD algorithm is implemented in the receiver, as is known in the art, this is not necessary since it automatically provides a source of data which is traffic free.

Any range or device value given herein may be extended or altered without losing the effect sought, as will be apparent to the skilled person from an understanding of the teachings herein.

1. A method of achieving uplink communication from a user terminal to a basestation in a wireless communications system said basestation supporting a plurality of such user terminals; said method comprising the steps of:
(i) for each of a plurality of the user terminals supported by the basestation transmitting a substantially continuous signal simultaneously from the user terminal to the basestation, said signals comprising a repeated spreading code word with a spreading factor and power level arranged such that the resulting background noise level is prevented from causing significant interference at the basestation in use even when more than 250 user terminals simultaneously transmit such continuous signals to the basestation; and
(ii) when a particular user terminal requires to send uplink information to the basestation, indicating this to the basestation by modulating the substantially continuous signal from that user terminal to the basestation.

2. A method as claimed in claim 1 wherein said indication is made by any or all of:
inverting the phase of the spreading code word;
using a reduced spreading factor;
applying a cyclic shift to the spreading code word;
applying a high order quadrature amplitude modulation (QAM) to the spreading code word;
sending additional spreading code words in parallel with the spreading code word of the substantially continuous signal.

3. A method as claimed in claim 1, wherein in said step (i) of transmitting, about 250 or more user terminals transmit the substantially continuous signals.

4. A method as claimed in claim 1 wherein said step (ii) further comprises sending uplink information from the particular user terminal to the basestation using the substantially continuous signal from that user terminal to the basestation and by increasing the information rate of that substantially continuous signal whilst the uplink information is sent.

5. A method as claimed in claim 4 wherein increasing the information rate of the substantially continuous signal during said step (ii) is achieved by any or all of:
applying a cyclic shift to the spreading code word;
applying a high order quadrature amplitude modulation (QAM) to the spreading code word;
sending additional spreading code words in parallel with the spreading code word of the substantially continuous signal.

6. A method as claimed in claim 1 wherein said substantially continuous signal comprises a deterministic, contentionless access channel.

7. A method as claimed in claim 1 wherein said wireless communications system is selected from a mobile, portable, or fixed wireless access system.

8. A method as claimed in claim 1 wherein during said step (i) of transmitting a substantially continuous signal, the spreading factor is about 4096 or higher.

9. A method as claimed in claim 1 which further comprises, at the basestation, receiving the substantially continuous signals and using them to estimate a channel impulse response for each of the user terminals.

10. A method as claimed in claim 1 wherein the substantially continuous signals from each user terminal are arranged to allow the basestation to identify each user terminal.

11. A method as claimed in claim 10 wherein the same spreading code word is repeated in each substantially continuous signal, but with a different cyclic shift being applied to the spreading code word associated with each user terminal.

12. A method as claimed in claim 10 wherein substantially orthogonal spreading code words are used for different user terminals.

13. A method of operating a basestation in a wireless communications system, said basestation supporting a plurality of user terminals, said method comprising:
(i) receiving a substantially continuous signal simultaneously from each of a plurality of the user terminals supported by the basestation, said signals comprising a repeated spreading code word with a spreading factor and power level arranged such that the resulting background noise level is prevented from causing significant interference at the basestation in use even when more than 250 user terminals simultaneously transmit such continuous signals to the basestation; and
(ii) receiving an indication from one of the user terminals which requires to send uplink information to the basestation, said indication being provided by a modulation of the substantially continuous signal from that user terminal to the basestation.

14. A method as claimed in claim 13 which further comprises in said step (ii) of receiving an indication from one of the user terminals, allocating processing resources of the basestation to receive and process uplink information from that user terminal.

15. A method as claimed in claim 13 which further comprises, in said step (i) of receiving a substantially continuous signals from each user terminal, using those signals to estimate a channel impulse response for each user terminal.

16. A basestation for use in a wireless communications system and arranged to support a plurality of user terminals, said basestation comprising:
(i) an input arranged to receive, at the same time, a substantially continuous signal from each of a plurality of the user terminals supported by the basestation, said signal comprising a repeated spreading code word with a spreading factor and power level arranged such that the resulting background noise is prevented from causing significant interference at the basestation even when more than 250 user terminals simultaneously transmit such continuous signals to the basestation; and
(ii) wherein said input is further arranged to receive an indication from one of the user terminals which requires to send uplink information to the basestation, said indication being provided by a modulation of the substantially continuous signal from that user terminal to the basestation.

17. A basestation as claimed in claim 16 which comprises a processor and an allocator arranged to allocate resources of that processor to receive and process uplink information from a user terminal which has made an indication that it requires to send uplink information.

18. A wireless communications network comprising a basestation as claimed in claim 17.

19. A computer program stored on a computer readable medium and arranged to control a basestation in order to carry out the method of claim 13.

20. A user terminal for use in a wireless communications system, said user terminal being one of a plurality of terminals supported by a basestation in the wireless communications network; said user terminal comprising:
(i) a transmitter arranged to transmit a substantially continuous signal to the basestation said signal comprising a repeated spreading code word with a spreading factor and power level arranged such that in use the resulting background noise level is prevented from causing significant interference at the basestation in use even when more than 250 user terminals simultaneously transmitting such continuous signals to the basestation; and
(ii) a processor arranged to modulate the substantially continuous signal in order to indicate to the basestation that it is required to send uplink information.
